(19) United States
(12) Patent Application Publication
(10) Pub. No.: US 2025/0370280 A1
(43) Pub. Date: Dec. 4, 2025

(54) VISOR SHIELD FOR SUNGLASSES AND EYEGLASSES

(71) Applicant: Kurt Gamnig, Mission Viejo, CA (US)

(72) Inventor: Kurt Gamnig, Mission Viejo, CA (US)

(21) Appl. No.: 18/732,029

(22) Filed: Jun. 3, 2024

(51) Int. Cl. G02C 11/00

(52) U.S. Cl. CPC G02C 11/12

(57) ABSTRACT

A visor shield for sunglasses and eyeglasses unique by the geometric relationship between the eyes and the edge of the beak. The lower surface of the visor shield is closer to the vertical center of the eyes making it more effective, thus enabling a shorter beak. One embodiment is for an attachable visor shield usable on many plastic sunglasses and eyeglasses. The single part embodiment features channels to enabling diverse tension forces for the retention of the sunglasses and eyeglasses. The additional embodiment shows an integrated visor shield into the frame of sunglasses and eyeglasses. The lower underside surface of the visor shield is enabling a geometrically closer relationship to the vertical center of the eyes, thus enabling a shorter beak. The benefits of the embodiments are a more effective design, more convenient to use, store and economical to manufacture.

### CROSS-REFERENCE TO RELATED APPLICATIONS

Not Applicable

### FEDERALLY SPONSORED RESEARCH

Not Applicable

### NAMES OF PARTIES TO A JOINT AGREEMENT

Not Applicable

### REFERENCE TO SEQUENCE LISTING

Not Applicable

### BACKGROUND OF THE INVENTION

The present invention is in the field of visor shields. Attachable and integrated visor shields for sunglasses and eyeglasses are included.

The following is a tabulation of some prior art that presently appears to be relevant.

| | | | |
|---|---|---|---|
| Patent Number | Kind Code | Issue Date | Patentee |

U.S. Patents

| | | | |
|---|---|---|---|
| 779,340 | A | 1905 Jan. 3 | Wynkoop |
| 1,911,842 | A | 1933 May 30 | Naulty |
| 2,052,772 | A | 1936 Sep. 1 | Jones |
| 2,055,386 | A | 1936 Sep. 22 | Peavey |
| 2,093,536 | A | 1937 Sep. 21 | Alvord |
| 2,224,560 | A | 1940 Dec. 10 | Wentz |
| 2,286,269 | A | 1942 Jun. 16 | Gilmartin |
| 2,544,221 | A | 1951 Mar. 6 | Creighton |
| 2,580,744 | A | 1952 Jan. 1 | Edsal |
| 2,640,988 | A | 1953 Jun. 9 | Poole |
| 2,762,050 | A | 1956 Sep. 11 | Bricker |
| 2,795,793 | A | 1957 Jun. 18 | Sommers |
| 2,819,468 | A | 1958 Jan. 14 | Van Dincklage |
| 2,891,251 | A | 1959 Jun. 23 | Ebersole |
| 3,011,170 | A | 1961 Dec. 5 | Lutz |
| 3,597,052 | A | 1971 Aug. 3 | Dittman |
| 4,446,571 | A | 1984 May 8 | Ross |
| 4,543,667 | A | 1985 Oct. 1 | Garbutt |
| 4,955,707 | A | 1990 Sep. 11 | Gazeley |
| 5,005,214 | A | 1991 Apr. 9 | Koethe |
| 5,335,025 | A | 1994 Aug. 2 | Wang |
| 5,438,378 | A | 1995 Aug. 1 | Blatter |
| 5,614,963 | A | 1997 Mar. 25 | Parker |
| 6,089,705 | A | 2000 Jul. 18 | Ertz |
| 6,247,177 | A | 2001 Jun. 19 | Hayes |
| 6,711,744 | B1 | 2004 Mar. 30 | Hockenbury |
| 6,957,889 | B1 | 2005 Oct. 25 | Steinbock |
| 9,459,471 | B1 | 2016 Oct. 4 | Neuman |
| 2,824,308 | A | 1958 Feb. 25 | Duncan |
| 3,555,563 | A | 1971 Jan. 19 | Grossman |
| 3,791,722 | A | 1974 Feb. 12 | Ahlberg |
| 5,189,445 | A | 1993 Feb. 23 | Stagner |
| 10,310,295 | B2 | 2019 Jun. 4 | Welt |

U.S. Patent Application Publication

| | | | |
|---|---|---|---|
| US 2007/0115425 | A1 | 2007 May 24 | Englebright |

Foreign Patent Documents

| | | | |
|---|---|---|---|
| AU3244971A | A | 1973 Feb. 22 | Dach |
| FR2846105 | A1 | 2004 Apr. 23 | Demagny |

There is a long patent history with respect to spectacle shades and solutions to improve devices. U.S. Pat. No. 779,340 to Wynkoop 1905 proposed a shade element for each eye with fastening elements using hooks and posts at the nose piece and outer edges of the spectacle. U.S. Pat. No. 1,911,842 to Naulty 1933 uses separate visors and needs customized frames and fastening to fit. U.S. Pat. No. 2,052,772 to Jones 1936 uses separate visors and spring clamps. U.S. Pat. No. 2,055,386 to Peavey 1936 uses a separate visor attached to the head. U.S. Pat. No. 2,093,536 to Alvord 1937 uses a flexible visor having slots to fasten to the wire frame side temples. U.S. Pat. No. 2,224,560 to Wentz 1940 uses multiple elements for fastening the visor to the spectacles. U.S. Pat. No. 2,286,269 to Gilmartin 1942 uses two shade elements into a customized frame to be attached. U.S. Pat. No. 2,544,221 to Creighton 1951 shows a large visor for spectacles using clips for fastening on the frame and side temples. U.S. Pat. No. 2,580,744 to Edsal 1952 is primarily concerned with the diversion of sweat from the forehead. In the modified version a visor is incorporated and fastened to the side temple pieces with a screw. U.S. Pat. No. 2,640,988 to Poole 1953 uses a visor for each eye. U.S. Pat. No. 2,762,050 to Bricker 1956 uses bows to fasten the visor to the spectacles. U.S. Pat. No. 2,795,793 to Sommers 1957 using strapping loops to fasten to the eyeglasses. U.S. Pat. No. 2,819,468 to Van Dincklage 1958 uses a support strip attached to the lens frame to insert such into a channel of the visor. U.S. Pat. No. 2,891,251 to Ebersole 1959 uses separate elements to attach the visor to the eyeglasses. U.S. Pat. No. 3,011,170 to Lutz 1960 shows a large visor using two resilient grooves for fastening. onto the lens rim of the spectacles. U.S. Pat. No. 3,597,052 to Dittman 1971 using multiple visor elements to fasten the spectacles. U.S. Pat. No. 4,446,571 to Ross 1984 using additional elements to fasten the visor to eyeglasses or sunglasses. U.S. Pat. No. 4,543,667 to Garbutt 1985 using elastic material loops to attach the visor to the side temples of eyeglasses. U.S. Pat. No. 4,955,707 to Gazeley 1990 using a pivoting mechanism to attach two sunshades. U.S. Pat. No. 5,005,214 to Koethe 1991 uses straps to fasten the visor to the outer part of the eyeglasses or sunglasses frame. U.S. patent by Wang 1994 shows a customized frame to accept the rather large sunshade. U.S. patent to Blatter 1995 uses separate clips attached to the visor to mount onto to the eyeglasses. U.S. Pat. No. 5,614,963 to Parker 1997 requires customized eyeglasses, sunglasses frames and the visor. U.S. Pat. No. 6,089,705 to Ertz 2000 involves embodiments with many parts, featuring also a movable visor. For attachment, some using clips or an adhesive. U.S. Pat. No. 6,247,177 B1 to Hayes 2001 shows a large visor attached to the side temples with an elastic material sewn into the headband. U.S. Pat. No. 6,711,744 B1 to Hockenbury 2004 shows a large bill visor attached to eyeglasses with many elastic loops located at the side temples. The U.S. Pat. No. 6,957,889 to Steinbock 2005 features separate shields for each lens and protects glare from the top of spectacles. It requires customized lenses and visors. U.S. Pat. No. 9,459,471 B1 to Neuman 2016 shows a top and two side shields. The visor attachment is by two slots on the side visor mating with the wireframe eyeglasses. Customization of the eyeglasses to accept the visor seems to be required. U.S. Pat. No. 2,824,308 to Duncan 1958 uses louvers on eyeglasses against glare. U.S. Pat. No. 3,555,563 to Grossman 1971 uses a restricted sight aperture. U.S. Pat. No. 3,791,722 to Ahlberg 1974 uses a shield which limits brightness. U.S. Pat. No. 5,189,445 to Stagner 1993 uses a slit in opaque lenses to limit peripheral distractions. U.S. Pat. No. 10,310,295 B2 to Welt 2019 uses many elements to create an aperture shield visor blocking light rays from the top, front, bottom and both sides.

Pub. No: US 2007/0115425 A1 by Englebright 2007 proposes magnetic material to retain a sun visor to the frame of glasses.

AU3244971A by Dach 1973 uses several elements to attach a visor shade to a frame.

FR2846105 by Demagny 2004 uses a one-piece silicon material visor with a straight slot to clip to sunglasses.

The prior art recognizes the benefits of a ray visor shield. The published devises contain separate visors, devices to attach to spectacles, eyeglasses and sunglasses. Some visors are complex or require customization to be compatible; others attempt to be more generic and simpler to fit mostly on wire-frame devices. Many appear not to be practical to use. There are apparent issues to attach the visors shields to the many varieties of generic frames of sunglasses and eyeglasses. The sunglasses and eyeglasses having an integrated visor shield are not optimized for efficiency and usefulness.

### SUMMARY

One embodiment of a visor shield comprises an attachable single body design made of a flexible material for sunglasses and eyeglasses. The additional embodiment comprises an integrated visor shield into the frame of sunglasses and eyeglasses. The design is optimized for an efficient solution and usefulness. The embodiment offers enhancing safety, comfort and convenience.

### BRIEF DESCRIPTION OF THE DRAWINGS

FIG. 1 shows a perspective view of the visor shield attached to a pair of sunglasses or eyeglasses frames.

FIG. 2 shows a forward perspective view of the attachable visor shield.

FIG. 3 shows an aft perspective view of the attachable visor shield.

FIG. 4 shows a forward perspective of the visor shield incorporated into sunglasses or eyeglasses frames.

FIG. 5 shows an aft perspective of the visor shield incorporated into sunglasses or eyeglasses.

### DRAWINGS—REFERENCE NUMERALS

100 sunglasses or eyeglasses frame
102 sunglasses or eyeglasses lens
104 sunglasses or eyeglasses lens
112 visor shield
114 clamp
116 clamp
118 vertical channel
120 vertical channel
122 recessive cut-out
200 sunglasses or eyeglasses frame
212 visor shield
214 top eye shield
216 top eye shield
222 recessive cut-out

### DETAILED DESCRIPTION

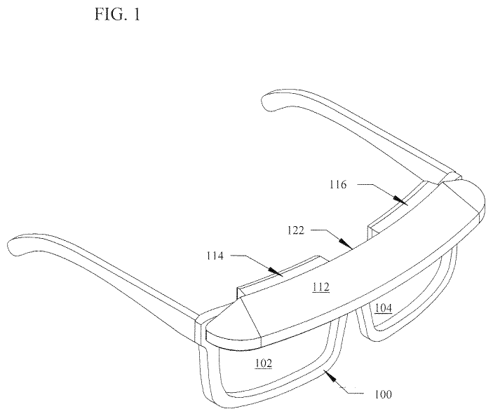

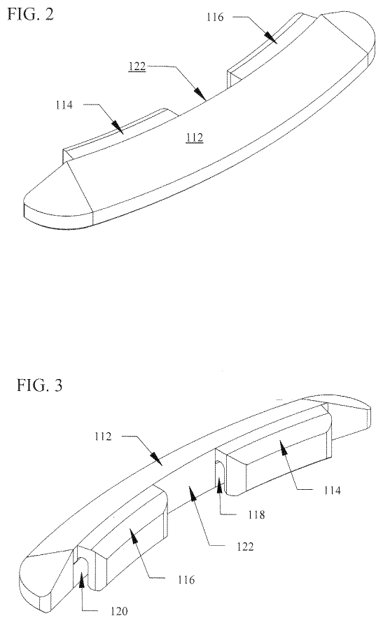

One embodiment of the mountable visor shield is illustrated in FIG. 1 FIG. 2 and FIG. 3 in perspective views.

FIG. 1 shows a visor shield 112 mounted on a pair of sunglasses respective eyeglasses frame 100. Said visor shield 112 is made of an elastic, either opaque or of limited translucent material. The visor shield has a relative short beak, comprises integrated clamps 114 and 116. The lateral center of the visor shield 112 has a recessive cut-out 122.

FIG. 2 shows a forward perspective view of the visor shield 112. The embodiment is of a crescent shape with tapered and rounded end shapes on each side. The top surface is sloped vertical downward to a forward end beak. The clamps 114 and 116 are integrated into the visor shield's body and having left and right rounded corners. In addition, the top rear edge of said clamps 114 and 116 are rounded. The lateral center of the visor shield 112 has a recessive cut-out 122.

FIG. 3 shows the aft perspective view of the visor shield 112. The clamp 114 embodies vertical curved channel 118 and the clamp 116 embodies vertical curved channel 120. More than one dimension of the mounting channel width is considered. The disposed vertical dimension of said channels lower's the underside surface of the visor shield 112. The lateral center of the visor shield 112 embodies a recess cut-out 122.

### Operation—FIG. 1, 3

Simply mount the single part visor shield 112 on a pair of sunglasses or eyeglasses frame 100 made of plastic. To accomplish this, the top edge rim of the sunglasses respective eyeglasses frame 100 is inserted into the channels 118 and 120. Center the visor shield 112 with respect to the lateral center of the sunglasses or eyeglasses frame 100. The disposition of the channel 180 and 120 enables the underside surface of the visor shield 112 to be closer aligned with the user's vertical center of the eyes not shown. Said disposition allows a better ray shielding property and the shorter beak of the visor shield. The width of the channel 118 and 120 is equal or slightly smaller than the width of the respective sunglasses or eyeglasses frame 100. Any difference between the arc of the curved channel 118 and 120 and the lateral curvature of the sunglasses and eyeglasses frame 100 will cause a side tension on said channel. The convex curvature of each sunglasses respective eyeglasses lens 102 and 104 exerts also a side tension on the channel 118 and 120. Any forward protruding part of the lateral center of the sunglasses respective eyeglasses frame 100 exerts a tension on the recessive cut-out 122 on the rear contact point of the visor shield 112. This will result in an additional side tension on the channel 118 and 120. The insertion of the top rim of the sunglasses respective eyeglasses frame 100 into the channel 118, 120 and the sum of lateral side tension on said channels accomplishes the retention of the visor shield 112 on the sunglasses respective eyeglasses frame 100. The disposition of the clamps 114 and 116 limits the migration of light between the backside of the sunglasses respective eyeglasses frame 100 and the wearer's eyes not shown. There is no contact between the visor shield 112 with the wearer's forehead or brows not shown, eliminating the accumulation of sweat. The visor shield 112 can be kept mounted, or conveniently stored alongside the sunglasses respective eyeglasses 100 in many available storage cases.

### Conclusion, Ramification, and Scope

The proposed visor shield offers a more effective, convenient and less cumbersome way of protecting and enhancing the vision of the eyes. The benefits of elimination of glare for comfort and safety are well established. While there are many devices to accomplish this, they are not often utilized due to their inconvenient size, complexity and cost. The usage of the visor shield and the benefits of such will be increased by having a more novel and convenient solution. The simple design of the visor shield enables a cost-effective way of manufacturing. The appearance of the shown embodiment is not limited in scope and can be modified and be different. The material of the visor shield can have different colors and contain ornamental artistic designs or images.

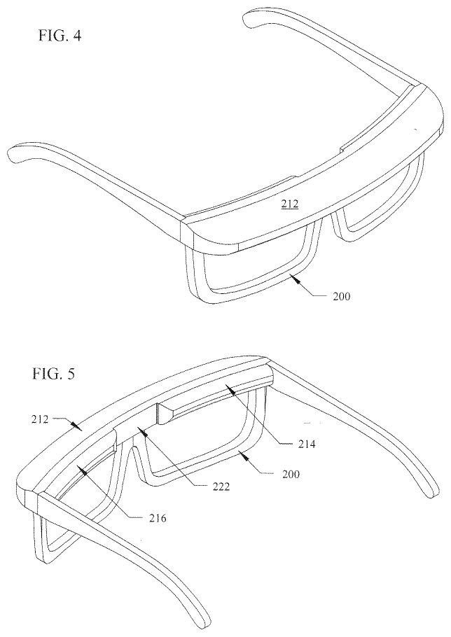

### FIG. 4, 5 Additional Embodiment

The visor shield 212 is integrated into the frame of sunglasses and eyeglasses 200 as shown in FIG. 4 and FIG. 5. Plastic opaque and limited translucent material is used to form the unified embodiment

FIG. 4 shows the forward perspective view of the sunglasses and eyeglasses frame 200 with the integrated visor shield 212. The embodiment conforms to the shape of the respective sunglasses and eyeglasses 200, with a relative short beak and rounded end shapes on each side. The top surface of the visor shield 212 is sloped vertical downward to a forward end beak. The disposition of said visor shield results in a lower underside surface thereof.

FIG. 5 illustrates the aft perspective view of the sunglasses and eyeglasses frame 200 with the integrated visor shield 212. Said visor shield 212 comprises top eye shields 214 and 216 which are rounded at the center location. The aft upper edge of the top eye shields is also rounded. The lateral center of the visor shield 212 embodies a recess cut-out 222.

### Operation FIG. 4, 5

The disposition of the top eye shields 214 and 216 minimize light migration between the backside of the sunglasses respective eyeglasses frame 200 and the wearer's eyes not shown. The disposition of the underside surface of the visor shield 212 is geometrically closer to the vertical center of the eyes not shown. This results in a more effective ray shielding property which allows a shorter visor shield 212 beak.

### CONCLUSION, RAMIFICATION, AND SCOPE

The proposed integrated visor shield offers a more effective, convenient and less cumbersome way of protecting and enhancing the vision of the eyes. The benefits of elimination of glare for comfort and safety are well established. The usage of the integrated visor shield will eliminate the need for a separate visor. The simple design of the visor shield enables a cost-effective way of manufacturing. The appearance of the shown embodiment is not limited in scope and can be modified and be different. The material of the visor shield can have different colors and contain ornamental artistic designs or images.

I claim:

1. A visor shield consisting of a single body comprising a lateral center recessive cutout and at least one clamps for attachment. The visor shield is having a short beak. The underside surface of said visor shield is relative lower with respect of the vertical center of the eyes.

2. The visor shield of claim 1 is disposed to have the means for an effective shorter dimension beak.

3. The visor shield of claim 1 comprising of an elastic opaque material.

4. The visor shield of claim 1 comprising of an elastic limited translucent material.

5. The visor shield of claim 1 clamp comprises at least one vertical channel having a width dimension, equal to or slightly smaller than the plastic rims of the sunglass's respective eyeglasses.

6. The visor shield of claim 1 whereby the clamp has a curved vertical channel.

7. The visor shield of claim 1 has the means for the retention caused by the side tension of any difference between the vertical channel and the lateral curvature of the sunglass's respective eyeglasses.

8. The visor shield of claim 1 has the means for the retention caused by the side tension of any convex curvature of a lens on the vertical channel of the sunglass's respective eyeglasses.

9. The visor shield of claim 1 has the means for retention by the side tension caused by any protruding part of the sunglass's respective eyeglasses on the rear contact point of said visor shield and the vertical channel.

10. The visor shield of claim 1 wherein said body using disposed clamps which enables the means for limiting the migration of light between the backside of the sunglass's respective eyeglasses frame and the wearer's eyes.

11. The visor shield of claim 1 whereby said body has the means to be attached to many existing sunglasses featuring a plastic frame.

12. The visor shield of claim 1 whereby said body has the means to be attached to many existing eyeglasses featuring a plastic frame.

13. The visor shield of claim 1 wherein said body has the means for no contact with the wearer's forehead, whereby eliminating the accumulation of sweat.

14. The visor shield of claim 1 wherein said body due to the small size, enabling means for storage alongside the sunglass's respective eyeglasses.

15. A visor shield with a short beak, integrated into the body of sunglasses and eyeglasses frame. Said visor shield has a body comprising a recessive cut-out at the lateral center. The underside surface of said visor shield is disposed closer to the vertical center of the eyes.

16. The visor shield in claim 15 is disposed of having the means for an effective shorter beak.

17. The visor shield in claim 15 comprising of an opaque material.

18. The visor shield in claim 15 comprising of a limited translucent material.

19. The visor shield in claim 15 wherein said body having a disposed aft top eye shield, thereby enables the means for limiting the migration of light between the backside of the sunglasses respective eyeglasses frame and the wearer's eyes.

20. The visor shield in claim 15 wherein said body has the means for no contact with the wearer's forehead, whereby eliminating the accumulation of sweat.
